(19) United States
(12) Patent Application Publication
(10) Pub. No.: US 2025/0101900 A1
(43) Pub. Date: Mar. 27, 2025

(54) Catalytic Converter Theft Prevention Device

(71) Applicant: Timothy William Edgin, Houston, TX (US)

(72) Inventor: Timothy William Edgin, Houston, TX (US)

(21) Appl. No.: 18/372,084

(22) Filed: Sep. 23, 2023

(51) Int. Cl. F01N 13/18; F01N 3/28; G08B 13/14

(52) U.S. Cl. CPC F01N 13/1805; F01N 3/28; G08B 13/1436; G08B 13/1481; F01N 2260/22

(57) ABSTRACT

An ink dispersal unit designed to spray someone attempting to illegally remove a catalytic converter. The would-be thief is then easily identified once he or she is covered in ink. The catalytic theft prevention device comprises of a vibration sensor, LiDAR sensor, wireless control, control module, encasing, and an ink dispersal unit.

### PRIOR ART

While there have been theft prevention devices in the past which help prevent the removal of catalytic converters such as U.S. Pat. No. 11,713,706, the prior art does not help identify the would-be thief.

### BACKGROUND OF THE INVENTION

Given enough time a determined thief will be able to steal a catalytic converter from a vehicle. While there are devices which are able to slow down a would-be thief, the present subject matter allows for the easy identification of someone illegally attempting to remove a catalytic converter.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

The present subject matter is an ink dispersal unit 20 designed to spray someone attempting to illegally remove a catalytic converter 30. The catalytic theft prevention device comprises of a vibration sensor 10, LiDAR sensor, wireless control, control module, catalytic converter encasing 30, and an ink dispersal unit 20.

In some embodiments, the present subject matter has GPS, audio alarm warning, and the ability to communicate with pre-existing alarm systems.

The present subject matter will allow the user to use a remote to disable the ink dispersal unit. In some embodiments this may be in the form of an application or a key fab.

The vibration sensor is only activated when the vehicle is in park. The vibration sensor 10 then works in combination with LiDAR 15 to detect motion underneath the vehicle. Once the catalytic converter theft prevent device detects both the presence of someone underneath the vehicle and vibrations above a predefined threshold, the ink dispersal unit ejects ink on the would-be thief.

The present subject matter is also encased in a metal covering to prevent easy access to the inner workings of the catalytic converter theft prevention device so as to prevent circumvention of the device.

The wireless control allows for the catalytic converter theft prevention device to communicate with the user's phone so that the use is able to deactivate the device.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

### DESCRIPTION OF DRAWINGS

FIG. 1 shows a schematic depiction of the catalytic converter theft prevention device.

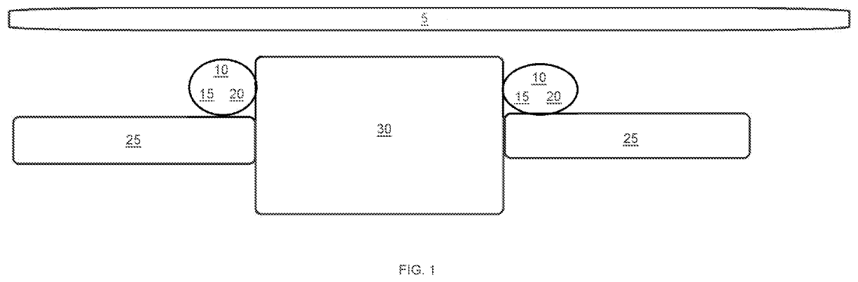

### LIST OF FIGURE ELEMENTS

5—Vehicle Under Belly.
10—Vibration Detection Sensor.
15—LiDAR.
20—Ink Dispersal Unit
25—Exhaust Pipe.
30—Catalytic Converter Encasing

1. A catalytic converter theft prevention device comprising of a vibration sensor, LiDAR sensor, wireless control, control module, encasing, and an ink dispersal unit.

2. The catalytic converter theft prevention device comprising of the vibration sensor, LiDAR sensor, wireless control, control module, encasing, and the ink dispersal unit as in claim 1, wherein the vibration sensor is only activated while the vehicle is in park.

3. The catalytic converter theft prevention device comprising of the vibration sensor, LiDAR sensor, wireless control, control module, encasing, and the ink dispersal unit as in claim 1, wherein the LiDAR sensor activates while the vehicle is in park to detect when someone is under the vehicle.

4. The catalytic converter theft prevention device comprising of the vibration sensor, LiDAR sensor, wireless control, control module, encasing, and the ink dispersal unit as in claim 1, wherein the vibration sensor has a predetermined threshold to determine when someone is attempting to steal a catalytic converter.

5. The catalytic converter theft prevention device comprising of the vibration sensor, LiDAR sensor, wireless control, control module, encasing, and the ink dispersal unit as in claim 1, wherein the vibration sensor and LiDAR sensor work in conjunction to determine when someone is attempting to steal the catalytic converter.

6. The catalytic converter theft prevention device comprising of the vibration sensor, LiDAR sensor, wireless control, control module, encasing, and the ink dispersal unit as in claim 1, wherein when the vibration sensor and LiDAR sensor detect someone is attempting to steal the catalytic converter the ink dispersal unit sprays the would-be thief.

7. The catalytic converter theft prevention device comprising of the vibration sensor, LiDAR sensor, wireless control, control module, encasing, and the ink dispersal unit as in claim 1, wherein catalytic theft prevention device's encasing is made of metal to prevent easy access to the inner workings of the catalytic converter theft prevention device so as to prevent circumvention of the device.

8. A method of manufacturing a catalytic converter theft prevention device comprising of a vibration sensor, LiDAR sensor, wireless control, control module, encasing, and an ink dispersal unit.

9. The method of manufacturing the catalytic converter theft prevention device comprising of the vibration sensor, LiDAR sensor, wireless control, control module, encasing, and the ink dispersal unit as in claim 8, wherein the vibration sensor is only activated while the vehicle is in park.

10. The method of manufacturing the catalytic converter theft prevention device comprising of the vibration sensor, LiDAR sensor, wireless control, control module, encasing, and the ink dispersal unit as in claim 8, wherein the LiDAR sensor activates while the vehicle is in park to detect when someone is under the vehicle.

11. The method of manufacturing the catalytic converter theft prevention device comprising of the vibration sensor, LiDAR sensor, wireless control, control module, encasing, and the ink dispersal unit as in claim 8, wherein the vibration sensor has a predetermined threshold to determine when someone is attempting to steal a catalytic converter.

12. The method of manufacturing the catalytic converter theft prevention device comprising of the vibration sensor, LiDAR sensor, wireless control, control module, encasing, and the ink dispersal unit as in claim 8, wherein the vibration sensor and LiDAR sensor work in conjunction to determine when someone is attempting to steal the catalytic converter.

13. The method of manufacturing the catalytic converter theft prevention device comprising of the vibration sensor, LiDAR sensor, wireless control, control module, encasing, and the ink dispersal unit as in claim 8, wherein when the vibration sensor and LiDAR sensor detect someone is attempting to steal the catalytic converter the ink dispersal unit sprays the would-be thief.

14. The method of manufacturing the catalytic converter theft prevention device comprising of the vibration sensor, LiDAR sensor, wireless control, control module, encasing, and the ink dispersal unit as in claim 8, wherein catalytic theft prevention device's encasing is made of metal to prevent easy access to the inner workings of the catalytic converter theft prevention device so as to prevent circumvention of the device.
